(19) United States
(12) Patent Application Publication
(10) Pub. No.: US 2005/0281043 A1
(43) Pub. Date: Dec. 22, 2005

(54) Side view mirror with light emitting trim ring

(76) Inventor: Kenneth D. Eisenbraun, Bloomfield Village, MI (US)

Correspondence Address: GIFFORD, KRASS, GROH, SPRINKLE & CITKOWSKI, P.C, PO BOX 7021, TROY, MI, 48007-7021, US

(21) Appl. No.: 10/978,736

(22) Filed: Nov. 1, 2004

Related U.S. Application Data
(60) Provisional application No. 60/515,633, filed on Oct. 30, 2003.

(51) Int. Cl. B60R 1/12

(52) U.S. Cl. 362/494; 362/492; 362/545; 362/511

(57) ABSTRACT

A light emitting mirror assembly for a vehicle is intended to side mount to the vehicle and includes a support element that provides a backing for the mirror and a trim portion that encompasses at least in part the perimeter of a mirror. The trim portion has a transparent or translucent light source housing cavity. A light source is disposed in the light source housing cavity and electrically connected to the vehicle such that light is emitted from the light source in response to an activation signal. A trim portion can include multiple light source housing cavities each of which can contain one or more light sources. The illuminated trim ring offers a mirror mounted turn signal indicator, puddle light, brake light, or decorative displays without resort to modifying the mirror face or reflections from the mirror face.

### RELATED APPLICATION

This application claims priority of U.S. Provisional Patent Application Ser. No. 60/515,633 filed Oct. 30, 2003, which is incorporated herein by reference.

### FIELD OF THE INVENTION

The present invention generally relates to a side view vehicle mirror that incorporates a turn indicator signal, and in particular to a side view vehicle mirror that incorporates a turn indicator signal in a trim ring about the mirror.

### BACKGROUND OF THE INVENTION

While turn indicators have traditionally been located at the corners of a vehicle to signal lane change or vehicle turning, there is now an appreciation that additional turn indicators are needed on side view mirrors. A side view mirror mounted turn indicator affords added visibility to a following vehicle, especially in situations where the following vehicle is close or when the equipped vehicle is pulling a trailer.

There have been numerous devices developed that incorporate light emitting diode (LED) indicator lights into the face of a side view mirror. Representative examples are found in U.S. Pat. No. 6,264,353; and U.S. Patent Application Publications U.S. 2002/0171954 and U.S. 2001/0024371. Additionally, devices have been contemplated that use a lens or reflector to project a turn indicator signal onto or through a mirror face. Representative examples are found in U.S. Pat. No. 5,587,699 and U.S. Patent Application Publication U.S. 2003/0107827. These prior art attempts have met with limited success owing to the increased complexity associated with modifying mirror surfaces to accommodate LEDs or the alignment of components. Thus, there exists a need for a side view mirror that incorporates a turn indicator independent of mirror modification or reflection therefrom.

### BRIEF DESCRIPTION OF THE DRAWINGS

FIG. 1 is a front view of an inventive exterior rearview mirror having an illuminated trim ring;

FIG. 2 is an exploded view of the mirror of FIG. 1 showing the backing portion and the electrical connections to the trim ring;

FIG. 3 is a rear view of an alternate embodiment of a support element and mirror combination operative in the instant invention;

FIG. 4A is a cross-sectional view of an inventive trim ring along the line 4A-4A of FIG. 2; and

FIG. 4B is a cross-sectional view in the vicinity of a light source along line 4B-4B according to FIG. 3.

### SUMMARY OF THE INVENTION

A light emitting mirror assembly for a vehicle is intended to side mount to the vehicle and includes a support element that provides a backing for the mirror and a trim portion that encompasses at least in part the perimeter of a mirror. The trim portion has a transparent or translucent light source housing cavity. A light source is disposed in the light source housing cavity and electrically connected to the vehicle such that light is emitted from the light source in response to an activation signal. A trim portion can include multiple light source housing cavities each of which can contain one or more light sources. The preferred light source is a light emitting diode. A light source within the trim ring is activated into emission based on a variety of stimuli such as engagement of a lock and key mechanism, receipt of a wireless signal, or vehicle operator activation of a turn signal mechanism. The illuminated trim ring offers a mirror mounted turn signal indicator, puddle light, brake light, or decorative displays without resort to modifying the mirror face or reflections from the mirror face.

### DESCRIPTION OF THE PREFERRED EMBODIMENTS

A light emitting mirror assembly for a vehicle includes a housing and a support element for supporting a mirror disposed within the housing. The housing has a proximal side which is proximal to an exterior side portion of a vehicle, and a distal side which is distal to the exterior side portion of the vehicle. The mirror has a front reflective surface, a rear surface, and edges, the combined lengths of the edges defining the perimeter of the mirror. The proximal side edge is proximal to an exterior side portion of a vehicle, and the distal side edge is distal to the exterior side portion of the vehicle.

The support element includes a backing portion and a trim portion. The backing portion is in connection with the rear surface of the mirror. Typically, the backing portion is adhered to the rear surface of the mirror by an adhesive such as glue, double-sided adhesive tape, and the like. The trim portion is connected to and extends along at least a portion of the perimeter of the mirror. Preferably, the trim portion extends along the entire perimeter of the mirror. Optionally, the trim portion is in contact with the front surface of the mirror.

The trim portion may be manufactured as an integral part of the support element. Alternatively, the trim portion is attached to the backing portion.

The trim portion is adapted to transmit light emitted from a light source included in the assembly. Thus, at least part of the trim portion is transparent to light emitted from the light source. In a preferred embodiment the trim portion proximal to the exterior side of the car is opaque to the light emitted from the light source. Optionally, regions of the trim portion are rendered opaque in order to achieve a patterned light effect, for example, regions of the trim portion may be alternately opaque and transparent. In a further option, regions of the trim portion may be made opaque and reflective, for instance to direct light away from the interior of the housing. In a preferred embodiment, at least a portion of the distal region of the trim portion is transparent to light emitted to the light source.

In a preferred embodiment, the trim portion is adapted to include a light source housing. A light source housing is a region of the trim portion adapted to receive a light source. In a preferred embodiment, the light source housing is an area of the trim portion defined by a space for insertion of a light source and a circuit board to which the light source is attached. Optionally, a focusing element such as a lens or reflector is included in the light source housing. A mirror assembly according to the present invention includes at least one light source and optionally multiple light sources. Thus, optionally included in an inventive mirror assembly are multiple light source housings. More than one light source may be inserted in a light source housing.

Referring now to the figures, a mirror assembly according to the present invention is shown generally at 10. The assembly 10 includes a housing 11. The housing includes a side 12 which is proximal to an exterior side portion of a vehicle V, and a distal side 13 which is distal to the exterior side portion of the vehicle V. Preferably, disposed within the housing 11 is a support element 14 having a backing portion 15 (shown in cutaway view) for supporting a mirror 26. The support element includes a trim portion shown at 42 bounding a portion of the mirror 26. The trim portion includes a light source housing cavity 16. The light source housing cavity 16 has a light source 31 residing therein. The light source housing cavity 16 is transparent or translucent. Optionally, the cavity 16 has a focusing element such as cube corners or other light reflective structures as detailed in U.S. Pat. No. 3,332,327. It is appreciated that light reflection from the cavity 16 is also enhanced by applying reflective coatings therein, as detailed in U.S. Pat. No. 6,325,515.

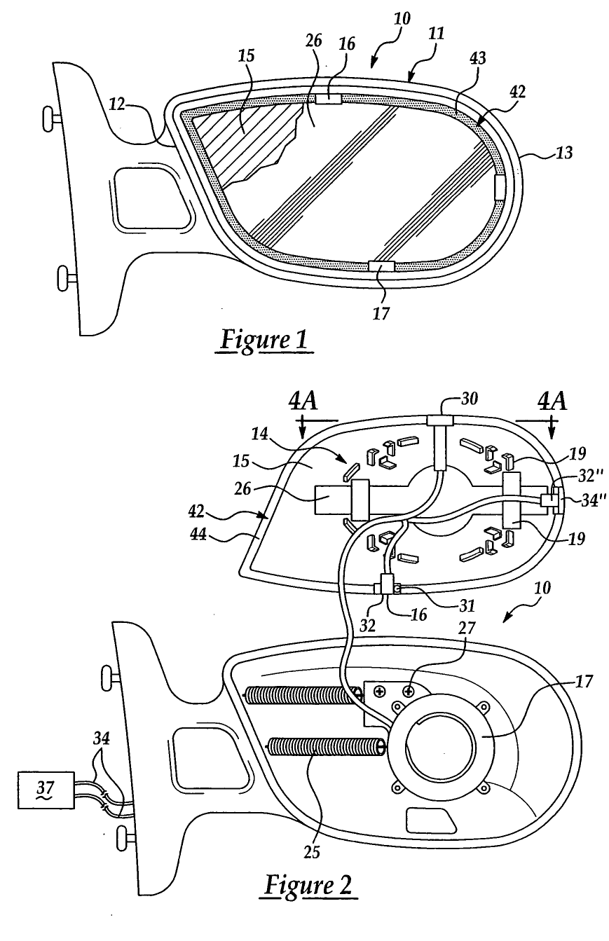

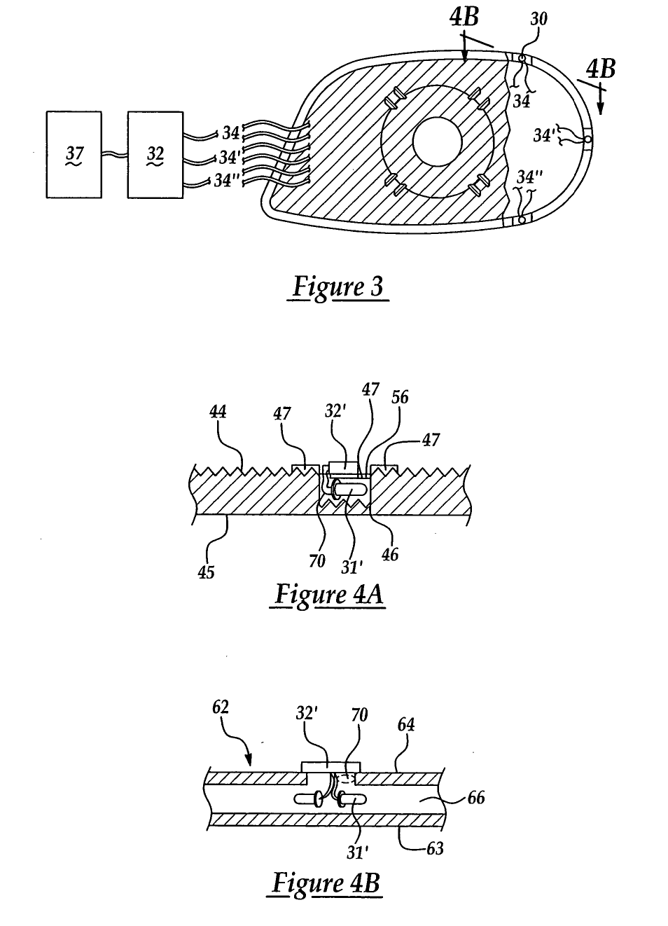

A light source is any of various types, illustratively including an incandescent bulb, an LED, and a cold cathode light emitter. An LED is the preferred light source 31. An inventive assembly typically has from one to twenty light sources and more preferably, two to ten light sources. An LED light source 31 is attached to a circuit board 32. Multiple LEDs 31, 31′ and 31″ are optionally connected by separate wire harnesses 33, 33′, and 33″ to a single circuit 35 as shown in FIG. 3 or alternatively, each light source 31 and 31′ may be attached to an individual circuit board 32 and 32′ as shown in FIG. 2. In the embodiment depicted in FIG. 2, a light source 31 is attached to a circuit board 32 and the circuit board 32 is adjacent to the light source housing 16. In the embodiment depicted in FIG. 4B, a circuit board forms a wall of the light source housing.

A light source 31 is powered by a vehicle electrical system as shown at 37 schematically. The light source may be activated in response to various stimuli, illustratively including engagement of a lock and key mechanism and transmission/reception of a wireless signal. In a preferred embodiment, activation of the light is in response to a vehicle operator's activation of a turn signal mechanism. Preferably a light source 31 included in a mirror assembly of the present invention flashes to signal to an observer outside the vehicle of an imminent movement of the vehicle in the general direction of the flashing light, for example, to indicate that the vehicle driver anticipates turning or changing lanes. The flashing light source may be connected such that it flashes in synchrony with a mirror and/or front turn signal indicator. It is understood that a light source 31 included in the mirror assembly 10 may be alternatively connected to indicate other functions of the vehicle. For instance, the light source 31 may be connected so as to indicate braking or rearward movement of the vehicle. In a further alternative embodiment, the light source 31 may be activated by wireless means; for instance, in response to a transmitter positioned on a key fob. Such activation may serve, for instance, as a visual indication to a vehicle owner of the position of the car in a parking garage or through directing the emission from the light source 31 downward to serve as a puddle light. It is also appreciated that activation of light source 31 may also serve a decorative function.

In a preferred embodiment, a plurality of light sources 31, 31′, and 31″ are included in an inventive mirror assembly. The plurality of light sources 31, 31′, and 31″ may be activated simultaneously or may be activated in a predetermined patterned fashion. For example, a plurality of light sources 31, 31′, and 31″ positioned along a trim portion 42 may be activated sequentially according to their respective position. The period of time between the activation of a first light source 31 of the plurality of light sources and a second light source 31′ may be varied to produce various effects, including a stroboscopic effect.

A light source 31 may be configured to have constant or variable intensity. For instance, in a variable intensity light source, the intensity of the light source may be conditioned on ambient light conditions by including a light sensor in the vehicle to which the light source is responsive.

A light source 31 emits any of various colors, depending on user preference and/or on local governmental regulations regarding vehicles. In a preferred embodiment, the light source emits red light. In an embodiment including more than one light source, generally all light sources will emit the same colored light; however, multiple colors may be used in a single assembly according to the invention. In general, where activation of the light serves an informational function such as an indication of turning, braking or backing, the light source will emit white, yellow, orange or red light, or combinations of these. However, colors such as green or blue are also contemplated.

As best illustrated in the exploded view of FIG. 2, the housing 11 has therein a mounting flange 17 adapted to engage complementary securement fittings 19 on the rear face 23 of the backing 14. While the mounting flange 17 is typically electrically powered by a motor within the housing 11, it is appreciated that the flange 17 is also readily repositioned by way of a manual control rod extending into the vehicle interior. Optionally, springs 25 are provided to tension the mounting flange 17 against a mechanical fastener 27 retaining the flange 17 to the interior 29 of the housing 11. Preferably, the backing portion 15 and the trim portion 42 are integral as a single support element 14. In instances where the backing portion 15 and the trim portion 42 are formed from different materials, joinder is accomplished with adhesives, sonic welding and other conventional joining techniques. More preferably, the support element 14 is injection molded from a conventional optically transparent thermoplastic. The mirror is retained in position with an adhesive 39. The housing 11 optionally has a transparent window 29 in the base thereof such that light emission from an inventive trim portion 42 reaches the ground beneath the assembly 10 and provides a puddle light function. It is appreciated that light source orientation dictates whether the light emission projects rearward in an indicator mode or downward in a puddle light mode. Additionally, it is appreciated that separate light sources may exist in concert within an assembly that operates in both modes.

The trim portion 42 proximal to the housing side 12 of the vehicle is optionally opaque to the light emitted from the light source 31. For example, in FIG. 1, the region of the trim portion 42 intermediate between light housings 16 and 17 in the direction towards the proximal side of the housing shown at 12. Where part of the trim portion is opaque, the trim portion may be composed of multiple pieces. Alternatively, a region of the trim portion may be rendered opaque by any various methods including application of paint, filling a bore of the trim portion with an opaque substance and the like. Additionally, it is appreciated that the backing portion 15 of the support element 14 may be opaque as well, as shown in FIG. 3.

FIG. 4A depicts a sectional view of an inventive assembly 10, taken along the line 3A-3A of the mirror 26 and support element 14 subassembly in the region of light source 31′ as depicted in FIG. 2. The trim portion 42 has a front surface at 43 and a rear surface 44. The light source housing cavity 16 includes an opening 56 in the rear surface 44 adapted to allow passage of a light source 31′ into the cavity 16 and an adjacent circuit board 32′, if needed for the particular light source 31′, namely an LED. The opening 56 is optionally sealed with an adhesive or the light source 31′ friction fit therethrough.

Optionally, a lens or focusing element 46 is included in the light source housing cavity 16. The lens or focusing element 46 is preferably in position between a light source 31′ and the front surface 43. A reflector 47 is optionally positioned within the cavity 16 or proximal thereto to lessen light scatter. Optionally, rear surface 44 has a texture matched to the appearance of the lens 46 when viewed from the front.

FIG. 4B illustrates a view identical to that of FIG. 4A in an alternative embodiment in which no lens or textured rear surface is included where like numerals correspond to those detailed with respect to previous figures. The trim portion 62, a rear surface 64, and an opening 72 in the rear surface 64 has a front surface 63 through which a light source 31 is introduced into an area between the front surface 62 and the rear surface 64 to provide a light source housing. The trim portion has a central bore 66. The bore 66 is exploited to render a section of the trim portion 42 opaque, or alternatively a mirror defrosting heating element extends therethrough.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A light emitting mirror assembly for a vehicle comprising:
a support element having a backing portion, a trim portion, the trim portion forming a transparent or translucent light source housing cavity;
a mirror supported on the backing portion; and
a light source disposed in the light source housing cavity, the light source connected to the vehicle such that light is emitted from the light source in response to an activation signal.

2. The mirror assembly of claim 1, further comprising:
a housing, said support element connected to said housing.

3. The mirror assembly of claim 1 wherein the trim portion and backing portion of said support element are integral.

4. The mirror assembly of claim 1 wherein the trim portion has a plurality of transparent or translucent light source housing cavities.

5. The mirror assembly of claim 4 wherein each of the plurality of cavities has at least one of said light source disposed therein.

6. The mirror assembly of claim 5 wherein said at least one light source is two or more light emitting diodes.

7. The mirror assembly of claim 1 wherein a segment of the trim portion is rendered opaque.

8. The mirror assembly of claim 1 wherein the trim portion has a central bore therethrough.

9. The mirror assembly of claim 1 wherein said support element is a thermoplastic.

10. The mirror assembly of claim 1 wherein the light source housing cavity further comprises a focusing element.

11. The mirror assembly of claim 10 wherein said focusing element is selected from the group consisting of: a lens and a reflector.

12. The mirror assembly of claim 2 wherein said support element is pivotally connected to said housing.

13. The mirror assembly of claim 2 wherein said housing further comprises a transparent window therein for light emission from said light source to project below said housing.

14. The mirror assembly of claim 1 further comprising a circuit board in electrical communication with said light source.

15. The mirror assembly of claim 14 wherein said circuit board is in electrical communication with a vehicle electrical system.

16. The mirror assembly of claim 15 wherein said circuit board initiates emission from said light source in response to the activation signal being selected from the group consisting of: engagement of a vehicle lock and key mechanism, reception of a wireless signal, and activation of a vehicle turn signal mechanism.

17. The mirror assembly of claim 1 wherein said light source has a periodic light emission.

18. The mirror assembly of claim 5 wherein the light sources have different emission colors.

19. A light emitting mirror assembly for a vehicle comprising:
a housing;
a support element secured within said housing, said support element having a backing portion, a trim portion, and a proximal side relative to the vehicle, the trim portion forming a plurality of transparent light source housing cavities;
a mirror supported on the back portion; and
a plurality of light sources disposed in the plurality of cavities, the plurality of light sources connected to a vehicle electrical system such that light is emitted from the plurality of light sources in response to an activation signal.

20. The mirror assembly of claim 19 wherein a segment of the trim portion is opaque.

21. The mirror assembly of claim 20 wherein the opaque portion encompasses the proximal side of said support element.

22. The mirror assembly of claim 19 wherein each of the plurality of cavities encompasses two or more light emitting diodes.

23. The mirror assembly of claim 19 further comprising a focusing element disposed within at least one of the plurality of cavities.

24. The mirror assembly of claim 23 wherein said focusing element is selected from the group consisting of a lens and a reflector.

25. The mirror assembly of claim 19 wherein said housing further comprises a transparent window therein for light emission from said light source to project below said housing.

26. The mirror assembly of claim 19 further comprising a circuit board in electrical communication with said light source.

27. The mirror assembly of claim 26 wherein said circuit board is in electrical communication with a vehicle electrical system.

28. The mirror assembly of claim 27 wherein said circuit board initiates emission from said light source in response to the activation signal being selected from the group consisting of: engagement of a vehicle lock and key mechanism, reception of a wireless signal, and activation of a vehicle turn signal mechanism.

29. The mirror assembly of claim 19 wherein said light source has a periodic light emission.

30. The mirror assembly of claim 19 wherein the light sources have different emission colors.
